(19) United States
(12) Patent Application Publication
(10) Pub. No.: US 2026/0091760 A1
(43) Pub. Date: Apr. 2, 2026

(54) SMART STORAGE SYSTEM

(71) Applicant: GM Global Technology Operations LLC, Detroit, MI (US)

(72) Inventors: Jacob Alan Bond, Rochester Hills, MI (US); Pallavi Gautam, Royal Oak, MI (US); Bo Yu, Troy, MI (US); Fatemeh Abolfazli Zargar, Birmingham, MI (US); Kiran Babu, Detroit, MI (US)

(21) Appl. No.: 18/904,349

(22) Filed: Oct. 2, 2024

(51) Int. Cl. B60R 25/31; B60R 25/10; B60R 25/102; B60R 25/25; B60R 25/30; G06V 20/56; G06V 40/16

(52) U.S. Cl. CPC B60R 25/31; B60R 25/102; B60R 25/25; B60R 25/305; G06V 20/56; G06V 40/172; B60R 2025/1016

(57) ABSTRACT

A vehicle includes multiple storage zones. A set of imaging sensors defines fields of view and each storage zone is included in at least one defined field of view. A controller is in communication with the set of imaging sensors and includes a set of processing modules configured to cooperatively implement a smart storage tracking system including a person recognition processing module and an object recognition processing module. The person recognition processing module includes a process for identifying unique persons using image analysis and the object recognition module includes a process for identifying unique objects using image analysis. The smart storage tracking system defines an object to person and location data entry in a database using the person recognition processing module and the object recognition processing module. The database is in communication with the controller and storing each defined object to person and location data entry.

### INTRODUCTION

The subject disclosure relates to object location monitoring within a vehicle using a smart storage system.

When planning and loading vehicles for a trip it is easy for the individuals loading the vehicle to lose track of one or more objects or think that an object has been packed or loaded when the object has been removed from the vehicle. This aspect is particularly exacerbated when a large number of objects are being loaded (e.g., in a commercial shipping truck) and when multiple people are independently responsible for loading items into the vehicle.

In addition, during a loading process it is common for objects to be removed, moved to different locations in the vehicle, and replaced resulting in difficulty tracking where any specific object is within the vehicle. This in turn makes unloading less efficient and increases the possibility of an object being forgotten, removed temporarily and inadvertently not being replaced prior to leaving on a trip, or otherwise misplaced.

As such, it is desirable to include an object tracking system within a vehicle, thereby reducing a cognitive load on individuals responsible for loading and unloading the objects.

### SUMMARY

In one exemplary embodiment A vehicle includes multiple storage zones. A set of imaging sensors defines fields of view and each storage zone is included in at least one defined field of view. A controller is in communication with the set of imaging sensors and includes a set of processing modules configured to cooperatively implement a smart storage tracking system including a person recognition processing module and an object recognition processing module. The person recognition processing module includes a process for identifying unique persons using image analysis and the object recognition processing module includes a process for identifying unique objects using image analysis. The smart storage tracking system is configured to define an object to person and location data entry in a database using person recognition of the person recognition processing module and object recognition of the object recognition processing module. The database is in communication with the controller and storing each defined object to person and location data entry.

In addition to one or more of the features described herein the set of imaging sensors includes a subset of exterior facing imaging sensors, and the subset of exterior facing imaging sensors define fields of view exterior to the vehicle.

In addition to one or more of the features described herein each object to person and location data entry includes data elements identifying a unique object and correlating a unique person and a unique location to the object, the unique location being one of a storage zone of the plurality of storage zones, a possession of a unique person, and a removed from vehicle status.

In addition to one or more of the features described herein the controller is further in communication with a remote device and configured to receive inputs from the remote device.

In addition to one or more of the features described herein the communication with the remote device is a direct communication.

In addition to one or more of the features described herein the communication with the remote device is indirect communication through a computing network.

In addition to one or more of the features described herein the vehicle further includes at least one stored trip list defining a plurality of unique objects and wherein the smart storage tracking system is configured to: determine a start of trip event has occurred, respond to the start of trip event by comparing a stored trip list of the at least one stored trip list to object to person and location an in vehicle subset of data entries in the database corresponding to object to person and location entries having location elements defined as vehicle zones, and respond to at least one unique object stored in the at least one stored trip list not corresponding to a unique object in the in vehicle subset of data entries by notifying at least one user of a missing item.

In addition to one or more of the features described herein the vehicle further includes at least one stored trip list defining a plurality of unique objects and wherein the smart storage tracking system is configured to determine an end of trip event has occurred, respond to an end of trip event occurring by comparing a stored trip list to object to person and location data entries in an in vehicle subset of data entries in the database corresponding to object to person and location entries having location elements defined as vehicle zones, respond to at least one unique object to person and location entry having a location element defined as a vehicle zone and corresponding to an object defined on the at least one stored trip list by providing a notification to a user. The notification includes an identification of a particular vehicle zone defined in the unique objects object to person and location data entry.

In addition to one or more of the features described herein the controller is configured to identify placement of a unique object in a vehicle by monitoring a set of image feeds of the set of image sensors, identifying a person carrying an object in at least one image feed of the set of image feeds and responding by identifying the person as a unique person using the person recognition processing module and identifying the object as a unique object using the object recognition processing module, determining that the unique person has left the unique object in a zone of the vehicle and responding by creating a new object to person and location data entry identifying the unique person, the unique object and the zone of the vehicle in which the unique object was left, and storing the new object to person and location data entry in the database.

In addition to one or more of the features described herein identifying unique persons includes running a facial recognition process on the at least one image feed of the set of image feeds.

In addition to one or more of the features described herein the person recognition processing module includes a process for identifying unique persons by identifying a token object carried by the unique persons.

In addition to one or more of the features described herein identifying the token object includes establishing an internet of things communication between the controller and the token object.

In addition to one or more of the features described herein the controller is configured to identify removal of a unique object from a vehicle by monitoring a set of image feeds of the set of image sensors and identifying a person interacting with objects stored in a zone of the vehicle using image analysis of the set of image feeds and identifying the person as a unique person and the object as a unique object, retrieving an object to person and location data entry corresponding to the unique object from the database, and responding to the identified unique person being different from the unique persons stored in the object to person and location data entry corresponding to the unique object by notifying a user that the unique object has been removed from the vehicle by an unauthorized person.

In addition to one or more of the features described herein the controller is further configured to respond to the unique person being the unique person stored in the object to person and location data entry corresponding to the unique object by updating a unique location data element of the object to person and location data entry to a removed from vehicle status.

In addition to one or more of the features described herein the controller further includes a local interface module configured to receive instructions from an input device and respond to receiving the instructions by determining an authorization level of a person providing the instructions and implement the instructions in response to the determined authorization level exceeding a minimum authorization level.

In addition to one or more of the features described herein the controller includes a manual object placement entry module configured to receive an object placement input defining a unique object, a unique location of the object and a unique person and configured generate an object to person and location data element based on the received object placement input.

In addition to one or more of the features described herein the manual object placement entry module includes a voice interface configured to receive an oral object placement input from at least one of a vehicle microphone and a remote device in communication with the controller.

In another exemplary embodiment a method for tracking objects in a vehicle includes identifying a presence of a person carrying an object in at least one image feed at least partially using an image analysis, determining a unique identity of the person using a combination of facial recognition image analysis and internet of things token identification, determining a unique object identifier of the object using image analysis, generating an object to person and location data entry including the unique object identifier and correlating the unique identity of the person and a location of the vehicle in which the object was left, and storing the object to person and location data entry in a database.

In addition to one or more of the features described herein the internet of things token identification includes a communication between a controller implementing the method and an internet of things enabled token carried by the person, and wherein the internet of things communication provides a unique identifier of the token to the controller.

In addition to one or more of the features described herein the method further includes identifying removal of the object from a vehicle by monitoring the at least one image feed and identifying the person interacting with objects stored in a zone of the vehicle using image analysis of the at least one image feed and identifying the person as a unique person and the object as a unique object, retrieving an object to person and location data entry corresponding to the unique object from the database, and responding to the identified unique person being different from the unique person stored in the object to person and location data entry corresponding to the unique object by notifying a user that the identified unique object has been removed from the vehicle by an unauthorized person.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top down schematic representation of a vehicle including a smart storage system;

FIG. 2 is a schematic representation of a smart storage system architecture for the vehicle of claim 1;

FIG. 3 is a process for tracking object placement using the smart storage system architecture;

FIG. 4 is a process for tracking object removal using the smart storage system architecture;

FIG. 5 is a process for implementing custom interactions using the smart storage system architecture; and

FIG. 6 is a process for tracking required objects for a trip using the smart storage system architecture.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Vehicles, such as passenger vehicles, commercial shipping trucks, and the like include smart infrastructure able to communicate with objects and devices possessed by the user using internet of things (IoT) techniques. In addition, such vehicles include cameras distributed about the vehicle which provide image feeds (e.g., video) to control systems that use the images for object detection and facial recognition. By leveraging the IoT techniques and a smart analysis of the image feeds the control systems pair objects with owners (i.e., people who placed the object in the vehicle) and track where the objects are placed in the vehicle.

In accordance with an exemplary embodiment methods, devices and systems are provided for implementing a smart storage system for tracking objects within a vehicle during a loading and unloading process. The smart storage system includes interior cameras and sensors positioned at key areas such as a glovebox, an etrunk, a frunk, and a traditional trunk and define regions of the vehicle as zones. The zones may be as broad as general areas of the vehicle 10 (i.e., a passenger compartment 14) or as narrow as a subdivided compartment (e.g., a rear right portion of a trunk). In alternate examples any number of other vehicle locations may be similarly monitored using video cameras or other sensors. The sensors interact with an Internet of Things (IoT) technology and an in-vehicle user interface to track positioning of the objects within the vehicle. Users can access storage information and/or receive reminders that items necessary for a daily commute or a specific trip are not in the vehicle prior to leaving on the trip.

Embodiments described herein present numerous advantages and technical effects. Included among the advantages and technical effects is a decrease in a cognitive load required to track objects during packing and or loading and unloading of a vehicle as well as identification of non-authorized individuals accessing or removing tracked objects from the vehicle.

The embodiments are not limited to use with any specific vehicle and may be applicable to various contexts. For example, the embodiments described herein may be applied to alternative systems beyond commercial shipping and private transportation including public transportation systems such as trains, busses and aircraft.

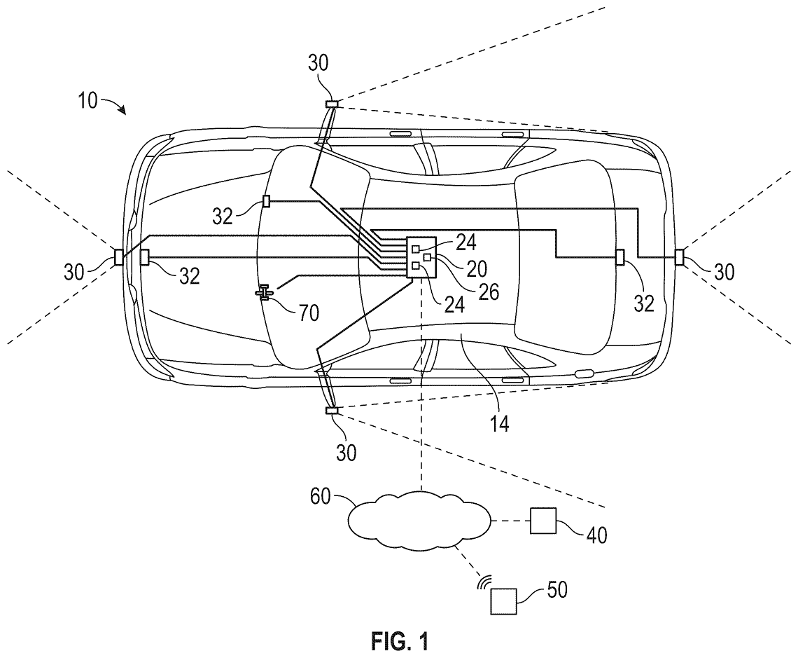

Referring to FIG. 1, the vehicle 10 includes a controller 20 in communication with a set of exterior facing cameras 30 and a set of interior cameras 32. Each exterior facing camera 30 defines a corresponding field of view in an area surrounding the vehicle 10. Each interior camera 32 captures an image feed of a portion of an interior of the vehicle 10. By way of example, a trunk camera 32 is directed toward the trunk and provides an image of the storage area of the trunk.

The controller 20 is further in communication with a remote computer system 40 and one or more mobile device 50, such as a phone and/or a tablet, through a cloud based computing system 60. In the illustrated example, the controller 20 is further in communication with an interior microphone 70. The interior microphone 70 is configured to receive voice commands and responses from a driver and/or vehicle operator within a passenger compartment 14 of the vehicle 10.

The controller 20 includes multiple processing modules 24 configured to receive and process inputs from the cameras 30, 32, the microphone 70 and through communication with the cloud 60 and remote mobile devices 50. The processing modules 24 are configured to implement an object pairing and tracking system which tracks a location and owner of objects and stores the pairing and tracking information in a database 26. In a practical example, the controller 20 can include any number of processing modules 24 defined in software and configured to operate in cooperation to implement the systems described herein. Two processing modules 24 are exemplary in nature, and alternate quantities of processing modules 24 may be utilized in alternate examples. While illustrated as contained within the controller 20 in the vehicle 10 of FIG. 1 it is appreciated that the database 26 may be stored remotely in the cloud 60 or in the remote computer system 40 and are accessible to the controller 20 through wireless communication.

The single dedicated controller 20 on the vehicle 10 illustrated in FIG. 1 may, in alternate examples, be a general vehicle controller including specialized functions for implementing the systems and processes described herein, a network of controllers including distributed functions and configured to work in conjunction with each other, or any similar controller configuration able to achieve the functions described herein.

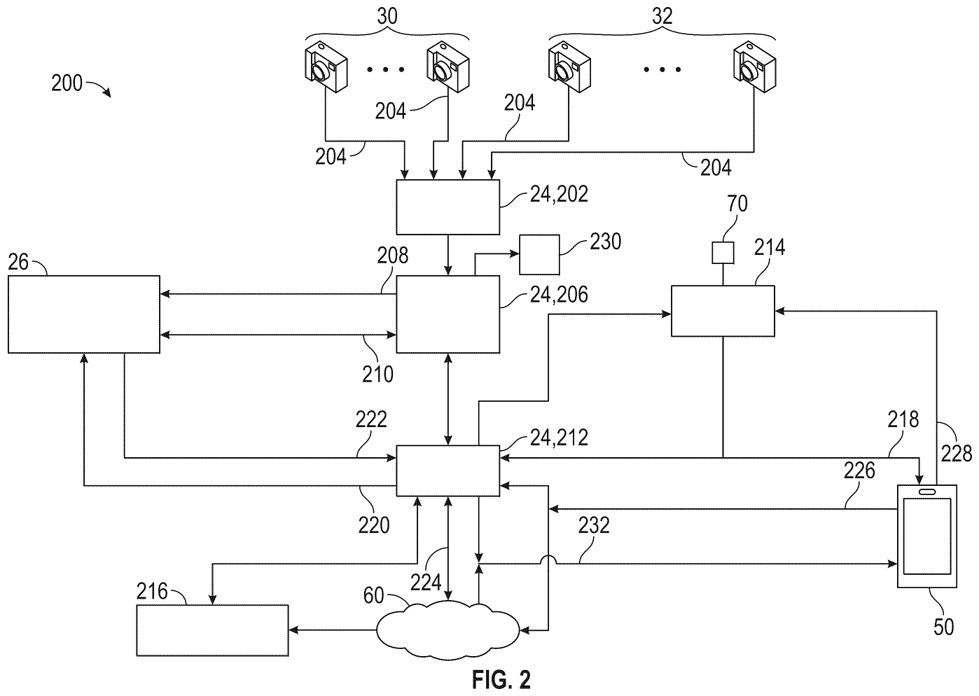

With continued reference to the vehicle 10 of FIG. 1, FIG. 2 illustrates an object pairing and tracking system architecture 200 (system architecture 200) for implementing an object pairing and tracking system within the vehicle 10. Portions of the system architecture 200 may be shared with other vehicle 10 systems or other remote systems and are not limited to use within the system architecture 200. By way of example, the exterior facing cameras 30 may simultaneously provide image feeds 204 to an object detection system and/or a driver assist system in addition to their use in the system architecture 200.

In the system architecture 200 each exterior facing camera 30 and each interior facing camera 32 provides their image feeds 204 to a video processor processing module 24, 202 (video processor 202). The video processor 202 uses image analysis techniques to isolate individual people and objects within the image feeds 204 from the cameras 30, 32. In addition to isolating individual people, the video processor 202 includes feature recognition processes able to distinguish individual people across multiple image feeds 204. By way of example, the feature recognition can include facial recognition and/or any other method of classifying individual people and distinguishing multiple individual people each other.

The identified people and objects in the image feeds 204 are passed to an interaction processor processing module 24, 206 (interaction processor 206). The interaction processor 206 monitors the identified objects and people within the image feeds 204 and tracks any interactions between the people, the objects, and zones of the vehicle 10. By way of example when an image feed 204 from an exterior camera 30 shows a person carrying a suitcase the interaction processor 206 pairs the particular suitcase with the particular person carrying the suitcase. When a subsequent image feed 204 from an interior camera 32 illustrates the suitcase being placed in the trunk, the interaction processor 206 identifies that the person has placed the suitcase in the trunk of the vehicle 10. In cases where the image feed 204 of the interior facing camera 32 includes enough footage of the person placing the suitcase (e.g., via an identifiable feature on an arm such as sleeve color, watch style, tattoo, etc.) the video processor 206 confirms that the person paired with the suitcase is the individual who placed the suitcase in the trunk. The resultant information generated by the interaction processor 206 is an object to person and location data entry including data elements identifying the object, who the object is paired with and what zone of the vehicle 10 the object is currently located in.

Each interaction identified by the interaction processor 206 is provided to the database 26 as an object interaction 208. The database 26 provides an object-to-person and location mapping of each identified object by storing each object to person and location data entry. The interactions 208 are generally characterized as three types: adding a new object to person or location pairing to the database 26, altering an existing object to person pairing in the database 26, and removing an object to person pairing from the database 26. In alternate systems one or more additional types of interactions 208 may be defined in the interaction processor 206.

In addition to providing interactions 208 to the database 26, the interaction processor 206 is configured to query the database 26 for information about one or more objects in the database 26 and receive a response 210 from the database 26.

A local interface processing module 24, 212 (local interface 212) receives inputs from multiple interface sources (e.g. a voice interface source 214, the cloud 60, a mobile device 50, an items required list 216, a vehicle touchscreen, or any other direct or indirect interface with a user. The local interface 212 processes received inputs and generates appropriate query responses based on the received input.

By way of example, the local interface 212 receives an input 218 of “I placed my spare keys in the glove box” from a voice interface 214 and the local interface 212 generates an instruction 220 altering an existing object to person and location pairing in the database 26. The instruction 220 alters a data entry for the user's keys to reflect placement of the keys in the vehicle glovebox within the database 26.

In another example, the local interface receives an input 218 of “where are my keys” from the voice interface 214, and generates a database 26 instruction that queries the database 26 for the current object to person and location pairing of the identified keys. In this example, the database 26 provides a query response 222 identifying the current object to person and location pairing of the keys and provides the query response 222 to the local interface 212.

The local interface 212 is further connected to the cloud 60 via a two way data connect 224 and/or the mobile device 50 via a wireless or wired connection allowing communication between the mobile device 50 and the local interface 212.

In another example, a user may utilize the mobile device 50, or any other similar interface, to create a list 226 of required items for a trip and provide the list 226 to either the local interface 212 or the cloud 60. The list 226 is then processed and provided to the items required list 216 which can be stored in a local or remote database or memory. The items required for trip list 216 is updated based on the received list 226, or a new items required for trip list 216 is created when the trip is different from any stored items required for trip lists 216. By way of example a user may make a list 226 for daily work commute, a separate list 226 for trips to children's activities, and another separate list 226 for specific one time trips and simultaneously stores all the lists 226 as distinct items required for trip lists 216.

In some examples, instead of directly connecting the voice interface 214 to the local interface 212, the system architecture 200 may pass the voice interface 214 through a mobile device 50 that is connected to the cloud 60 and the local interface 212. In addition, when the mobile device 50 includes an audio input, the mobile device 50 may provide audio to the voice interface 214 in addition to the microphone 70 providing audio input to the voice interface 214.

The local interface 212 may provide outputs in response to queries or other actions through a connection with an interior vehicle screen 230, or through a communication 232 with the mobile device 50. The interior vehicle screen 230 and/or mobile device 50 then provides an output display corresponding to the particular query response.

The specific connections, commands, and structures of the system architecture 200 exemplify one possible embodiment of the systems and process described herein. Alternate embodiments may include more and/or alternate interfaces or connections and may utilize different database structures to achieve similar functionality.

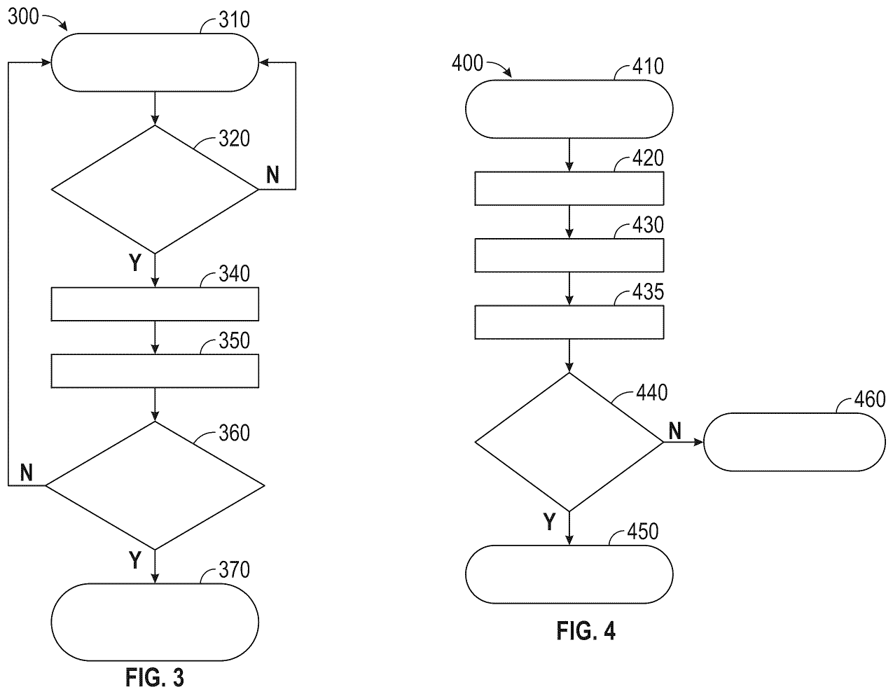

With continued reference to the vehicle 10 of FIG. 1 and the system architecture 200 of FIG. 2, FIG. 3 illustrates an example process 300 for adding an object to person and location pairing data to the database 26 in the vehicle 10. Initially the process 300 waits for a person to enter a storage area in a wait for person to enter storage location step 310. The process 300 identifies a person as entering the storage area either by analyzing an image feed 204 capturing the corresponding zone and an area approaching the corresponding zone or identifying a token object (e.g. mobile device 50, a satellite tracking tag, or any other token object uniquely tied to the person using an internet of things system) entering the same area.

Once a person has entered the zone, the process 300 analyzes image feed 204 of the zone to determine if the person is in possession of one or more objects in a possession check 320. If the person is not in possession of any objects, the process 300 returns to the initial step 310 and resumes waiting.

If the person is in possession of one or more objects, the image feed 204 is processed using facial recognition and/or another image processing technique to uniquely identify the specific person in a facial recognition step 340 and the specific object(s) being carried are identified using object recognition processing techniques in an object detection step 350. The object recognition processes can be any existing image analysis techniques and/or IoT communications.

While illustrated in the process 300 of FIG. 3 as sequential steps 340, 350, the facial recognition and the object detection may take place simultaneously using different processing systems or the order may be reversed with the object detection step 350 occurring before the facial recognition step 340.

After identifying the person and any objects in steps 340, 350, the process 300 checks to determine if the person has left the object in the storage zone in a did person leave object in storage zone check 360. When no objects were left, the process 300 returns to the waiting step 310. When one or more objects is left in the storage zone, the process 300 identifies which object was left, generates an add object to person and location pairing instruction, and provides the instruction to the database 26 in an add object to person or location association to database step 370. The instruction associates the object with the person who left the object in the zone and the particular zone in which the object was left and causes the database 26 to either update an existing entry for that particular object or create a new entry for that object in the database 26.

With continued reference to FIGS. 1 and 2, FIG. 4 illustrates a process 400 for tracking object removal using the smart storage system architecture 200 of FIG. 2. Initially the process 400 waits for a person to interact with an object in the vehicle 10 in a wait for object interaction step 410. An object interaction can be detected by the process 400 via monitoring weight sensors within a zone (e.g., when a weight sensor indicates a decreased weight, the controller 20 determines that an object has been lifted), monitoring an image feed 204 of the zone, tracking a position of an object using an IoT connection with the object, or any similar process.

When an object has been interacted with, the process 400 proceeds to analyze the image feed 204 of the zone to determine the unique person who performed or is performing the interaction using a facial recognition step 420 and to determine which object(s) have been interacted with in an object detection step 430. The facial recognition step 420, and the object detection step 430 operate in generally the same manner as the corresponding steps 340, 350 of the process 300 of FIG. 3.

The process 400 continues monitoring the image feed 204 and determines when the object has been removed from the zone in an object removed from zone step 435.

After identifying the person interacting with the object using the facial recognition step 420 and the object being interacted with in the object detection step 430 and determining that the object has been removed from the zone in the object collected step 435, the process 400 determines if the person interacting with the object is authorized to collect the object in an authorization check 440. In some examples, the person is determined to be authorized to collect the object(s) when the identified person is the person paired with the object(s) in the database 26. In other examples, the database 26 may include a further entry for objects listing specific individuals who are allowed to collect the object.

In either case, when the authorization check 440 determines that the person interacting with the object(s) is authorized, the process 400 proceeds to generate an instruction removing the object from the database 26 and indicating the person who collected the object in a remove object from database step 450.

When the authorization check 440 determines that the person interacting with the object(s) is not authorized, the process 400 proceeds to alert one or more people associated with the object in the database 26 that an unauthorized person has interacted with the object in an alert object owner of interaction step 460. The alert can be provided to the object owner via a corresponding mobile device 50, a screen 230 within the vehicle 10, an e-mail or text notification, or any other established notification methodology.

In alternate examples of the process 400, the process 400 can omit monitoring for objects to be removed, performed in the object removed step 435, and immediately check for authorization via the authorization check 440 in response to the object being interacted with.

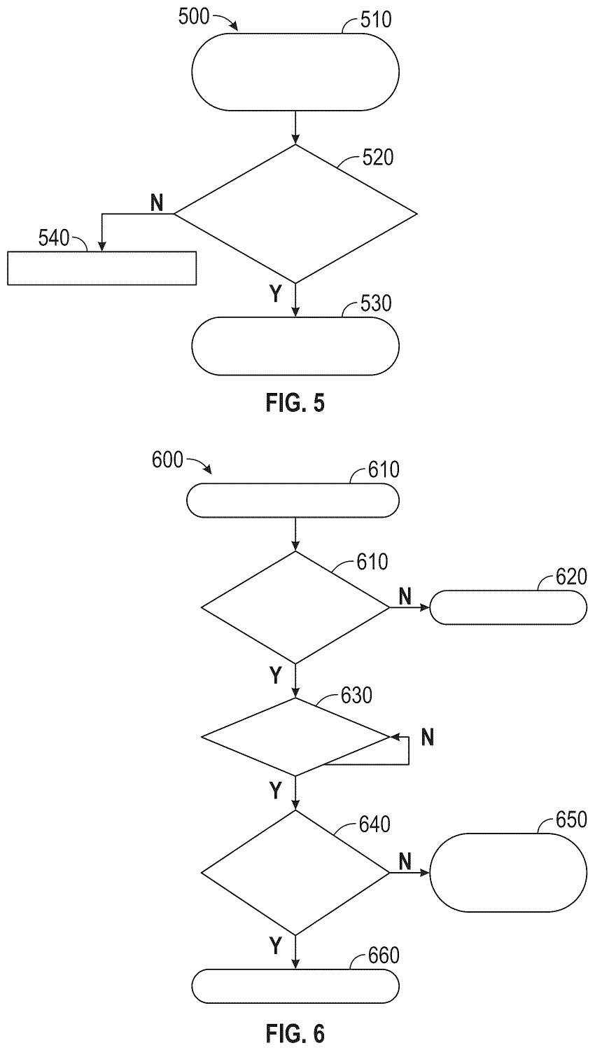

With continued reference to FIGS. 1-4, FIG. 5 is a process 500 for custom interactions using the smart storage system architecture 200 in the vehicle 10. The process 500 waits for a custom interaction input in a wait for input step 510. Custom interactions can include the creation of trip lists for one or more trips, manual associating objects in the database 26 with one or more persons, and manually setting an intended location for an object target (E.G., the object should be in the vehicle, or the object should be removed from the vehicle.)

For each input, the process 500 checks to determine if the person providing the input is authorized to provide the requested interaction in an authorization check 520. For manual modifications to a database entry in the database 26 a person is authorized if they are the person associated with the object entry being modified. For other actions, such as saving, altering or removing items required on list 216, a user is authorized based on general access authorization levels stored in the controller 20 and can be limited in any available scheme. By way of example, an owner of the vehicle 10 may have general authorization to make any modifications and may assign specific rights and privileges to a subset of other users of the vehicle 10. In another example, an originator of a given list may be default assigned as authorized to modify the items required list 216.

When the user is authorized to make the request, the process 50 proceeds to implement the request in a modify database based on interaction step 530. When the user is not authorized to make the request, the process 500 proceeds to block the interaction in a block interaction step 540. In some examples, the block interaction step 540 may further include notifying one or more persons who would be authorized to make the request that a request from an unauthorized person has occurred. The authorized individual may, in further examples, authorize the request or implement the request themselves.

With continued reference to FIGS. 1-5, FIG. 6 illustrates a process 600 for ensuring that all items included on a given trip list are present during the trip. Initially the process 600 waits for an indication that the trip is beginning in a wait for trip to begin step 610. The trip beginning step 610 may be a manual input by a driver of the vehicle 10 that the trip is about to start, an ignition of the vehicle 10 at a scheduled or learned trip time, a scheduled trip start time, or any other method of indicating that the trip is beginning.

When the trip begins, the process 600 proceeds to check if all required items for the trip are in the vehicle 10 in an are all required items present check 610. During the check 610, a processor module 24 identifies each item on a corresponding items required list 216 for the trip in the database 26 and determines if the object to person and location associations of the items indicate that the object is present in the vehicle 10. If any objects included in the items required list 216 are not present in the vehicle 10, or are not included in the database 26, the process 600 alerts the user in an alert user step 620. The alert is provided prior to the vehicle 10 leaving on the trip, thereby allowing the users to identify the missing objects and retrieve the missing objects.

When all objects are present in the database 26 and associated with a location in the vehicle 10, the process 600 runs an iterative check 630 to determine if the trip has ended. The trip may be indicated as having ended in response to the vehicle 10 reaching a prestored global navigation system destination, a manual indication by a user of the system, the vehicle 10 being stopped for greater than a predetermined length of time, or any other method.

Once the trip is completed, the process 600 allows the users to collect objects from the vehicle 10 and checks to determine if all required items have been collected from the vehicle in a required items collected check 640. If any required items have not been collected, the process 600 notifies the users that the objects have not been collected, and of where the uncollected objects are positioned in the vehicle 10 in an alert user to location of missing objects step 650.

Once all objects have been collected, the trip is fully completed and the process 600 ceases in an end trip step 660.

The processes outlined in FIGS. 3-6 provide general use cases for the object tracking system architecture 200 of FIG. 2 and are not limiting in nature. Additional or alternative use cases may be incorporated alongside the illustrated use cases and still fall within the auspices of this disclosure.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
a plurality of storage zones;
a set of imaging sensors defining fields of view, wherein each storage zone is included in at least one defined field of view;
a controller in communication with the set of imaging sensors, the controller including a set of processing modules configured to cooperatively implement a smart storage tracking system including a person recognition processing module and an object recognition processing module, wherein the person recognition processing module includes a process for identifying unique persons using image analysis and wherein the object recognition processing module includes a process for identifying unique objects using image analysis;
the smart storage tracking system being configured to define an object to person and location data entry in a database using person recognition of the person recognition processing module and object recognition of the object recognition processing module; and
the database being in communication with the controller and storing each defined object to person and location data entry.

2. The vehicle of claim 1, wherein the set of imaging sensors includes a subset of exterior facing imaging sensors, and the subset of exterior facing imaging sensors define fields of view exterior to the vehicle.

3. The vehicle of claim 1, wherein each object to person and location data entry includes data elements identifying a unique object and correlating a unique person and a unique location to the object, the unique location being one of a storage zone of the plurality of storage zones, a possession of a unique person, and a removed from vehicle status.

4. The vehicle of claim 1, wherein the controller is further in communication with a remote device and configured to receive inputs from the remote device.

5. The vehicle of claim 4, wherein the communication with the remote device is a direct communication.

6. The vehicle of claim 4, wherein the communication with the remote device is indirect communication through a computing network.

7. The vehicle of claim 1, further comprising at least one stored trip list defining a plurality of unique objects and wherein the smart storage tracking system is configured to:
determine a start of trip event has occurred;
respond to the start of trip event by comparing a stored trip list of the at least one stored trip list to object to person and location an in vehicle subset of data entries in the database corresponding to object to person and location entries having location elements defined as vehicle zones; and
respond to at least one unique object stored in the at least one stored trip list not corresponding to a unique object in the in vehicle subset of data entries by notifying at least one user of a missing item.

8. The vehicle of claim 1, further comprising at least one stored trip list defining a plurality of unique objects and wherein the smart storage tracking system is configured to:
determine an end of trip event has occurred;
respond to an end of trip event occurring by comparing a stored trip list to object to person and location data entries in an in vehicle subset of data entries in the database corresponding to object to person and location entries having location elements defined as vehicle zones; and
respond to at least one unique object to person and location entry having a location element defined as a vehicle zone and corresponding to an object defined on the at least one stored trip list by providing a notification to a user, wherein the notification includes an identification of a particular vehicle zone defined in the unique objects object to person and location data entry.

9. The vehicle of claim 1, wherein the controller is configured to identify placement of a unique object in a vehicle by:
monitoring a set of image feeds of the set of image sensors;
identifying a person carrying an object in at least one image feed of the set of image feeds and responding by identifying the person as a unique person using the person recognition processing module and identifying the object as a unique object using the object recognition processing module;
determining that the unique person has left the unique object in a zone of the vehicle and responding by creating a new object to person and location data entry identifying the unique person, the unique object and the zone of the vehicle in which the unique object was left; and
storing the new object to person and location data entry in the database.

10. The vehicle of claim 1, wherein identifying unique persons includes running a facial recognition process on the at least one image feed of the set of image feeds.

11. The vehicle of claim 1, wherein the person recognition processing module includes a process for identifying unique persons by identifying a token object carried by the unique persons.

12. The vehicle of claim 11, wherein identifying the token object includes establishing an internet of things communication between the controller and the token object.

13. The vehicle of claim 1, wherein the controller is configured to identify removal of a unique object from a vehicle by monitoring a set of image feeds of the set of image sensors and;
identifying a person interacting with objects stored in a zone of the vehicle using image analysis of the set of image feeds and identifying the person as a unique person and the object as a unique object;
retrieving an object to person and location data entry corresponding to the unique object from the database; and
responding to the identified unique person being different from the unique persons stored in the object to person and location data entry corresponding to the unique object by notifying a user that the unique object has been removed from the vehicle by an unauthorized person.

14. The vehicle of claim 13, wherein the controller is further configured to respond to the unique person being the unique person stored in the object to person and location data entry corresponding to the unique object by updating a unique location data element of the object to person and location data entry to a removed from vehicle status.

15. The vehicle of claim 1, wherein the controller further includes a local interface module configured to receive instructions from an input device and respond to receiving the instructions by determining an authorization level of a person providing the instructions and implement the instructions in response to the determined authorization level exceeding a minimum authorization level.

16. The vehicle of claim 1, wherein the controller includes a manual object placement entry module configured to receive an object placement input defining a unique object, a unique location of the object and a unique person and configured generate an object to person and location data element based on the received object placement input.

17. The vehicle of claim 16, wherein the manual object placement entry module includes a voice interface configured to receive an oral object placement input from at least one of a vehicle microphone and a remote device in communication with the controller.

18. A method for tracking objects in a vehicle comprising:
identifying a presence of a person carrying an object in at least one image feed at least partially using an image analysis;
determining a unique identity of the person using a combination of facial recognition image analysis and internet of things token identification;
determining a unique object identifier of the object using image analysis;
generating an object to person and location data entry including the unique object identifier and correlating the unique identity of the person and a location of the vehicle in which the object was left; and
storing the object to person and location data entry in a database.

19. The method of claim 18, wherein the internet of things token identification includes a communication between a controller implementing the method and an internet of things enabled token carried by the person, and wherein the internet of things communication provides a unique identifier of the token to the controller.

20. The method of claim 18, wherein the method further includes identifying removal of the object from a vehicle by:
monitoring the at least one image feed and identifying the person interacting with objects stored in a zone of the vehicle using image analysis of the at least one image feed and identifying the person as a unique person and the object as a unique object;
retrieving an object to person and location data entry corresponding to the unique object from the database; and
responding to the unique person being different from the unique person stored in the object to person and location data entry corresponding to the unique object by notifying a user that the unique object has been removed from the vehicle by an unauthorized person.
